(19) United States
(12) Patent Application Publication
(10) Pub. No.: US 2012/0201367 A1
(43) Pub. Date: Aug. 9, 2012

(54) Telephone Line Sensor and Redialer

(75) Inventors: Rachel Sara Honig, Hashmonaim (IL); Dror Zelber, Ramat-Gan (IL)

(73) Assignee: MICROSOFT CORPORATION, Redmond, WA (US)

(21) Appl. No.: 13/023,659

(22) Filed: Feb. 9, 2011

(51) Int. Cl. H04M 3/42

(52) U.S. Cl. 379/207.02

(57) ABSTRACT

The subject disclosure is directed towards a technology by which a caller can set his or her cellular phone or similar device to automatically sense a called party's busy telephone line for when it becomes free, independent of any carrier-provided monitoring service. If free, the caller is prompted with an option to automatically redial the called party. The called party's line may be sensed seamlessly, that is, without any caller action and/or realization by the called party phone that it is being sensed (e.g., no missed call detected), by processing status messages obtained in response to quickly canceled calls. The lines of more than one called party may be sensed in the same timeframe to determine when each is free.

### BACKGROUND

When calling someone by telephone, a busy signal is often received. Other non-ringing events may instead occur, such as a placed call simply being disconnected after a frustrating wait of no ringing. In general, the caller needs to keep calling until he or she gets the called party's telephone to ring, whereby the called party may answer or voice mail messaging may be initiated.

One landline telephone carrier offers a service that allows a user who has received a busy signal to be notified when the last called party's line becomes free. In general, the caller that receives the busy signal dials a code, and the central switching office monitors the called line and notifies the caller when the line becomes free.

However, there is a financial charge for using this service, and moreover the service is of limited usefulness. For one, any party can cancel the option to have its line monitored, and such parties that do so tend to be those where the service is likely useful, e.g., a government office or other large entity with a line that is very often busy. For another, the service is entirely manual, as the user needs to remember the code and remember to input it when needed. Still further, the service applies to only one called party at a time.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a telephone line is automatically sensed to determine when the telephone line becomes free, which may be based on a user instruction following a prompt, such as when no actual conversation is detected with respect to a conventional call attempt. Sensing is performed independent of the service provider, such as in the calling telephone, by making calls directed to the telephone line, processing status messages returned in response to the calls, and canceling the calls. The sensing-related calls may be canceled before they are detected at the called party device, e.g., as a missed call. Further action is taken when a status message indicates that the line is free, including notifying a user as to the line having a free status, and redialing the line if the user requests redialing.

Sensing may be halted by user request, or by a retry limit being reached, which may be a user configurable parameter. The wait time between sensing call attempts may also be user configurable. More than one telephone line may be sensed in the same timeframe.

In one aspect, a redialer sensor mechanism that operates to sense the line, and a user interface are provided to provide the user with a line sensing and redialer service, e.g., within a user-owned device. The user interface may notify the user when the line becomes free via an audible, visible and/or tactile (e.g., vibration) notification, and may prompt the user to select whether to redial a conventional call. The redialer sensor mechanism may be incorporated into a mobile telephone, a VolP telephone, a software application program, an add-on telephone device, and so forth.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components implemented in a telephone device for performing line sensing and redialing when a previously busy telephone line is detected as being free.

FIG. 2 is a timing diagram showing how a busy call may result in line sensing and redialing based on sensing and user interaction.

FIG. 3 is a flow diagram representing example steps for performing line sensing and redialing-related operations.

FIG. 4 is a block diagram representing an exemplary non-limiting computing system or operating environment, e.g., in the example of a mobile phone device, in which one or more aspects of various embodiments described herein can be implemented.

### DETAILED DESCRIPTION

Various aspects of the technology described herein are generally directed towards a technology by which a caller can set his or her phone to automatically sense a called party's telephone line, independent of any carrier-provided monitoring service, until the line becomes free or a caller-configurable limit is reached. Note that as used herein, the term “telephone line” corresponds to a telephone number or name/address, whether or not the “line” comprises an actual physical wired connection or a wireless connection, or some combination thereof. If free, the caller may redial the called party. The called party's line may be sensed seamlessly, that is, without any caller action and/or realization by the called party phone that it is being sensed, and the lines of more than one called party may be sensed to determine when each is free.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in telephony and communications in general.

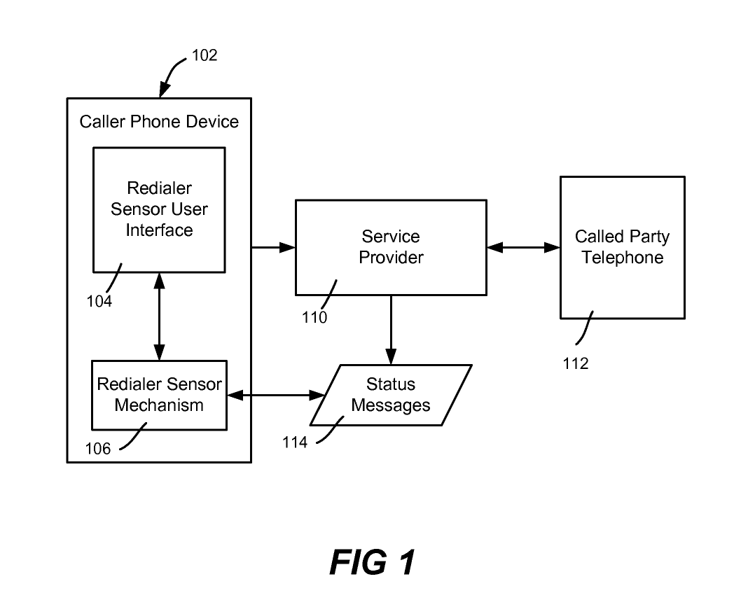

FIG. 1 shows example components for implementing automatic sensing and redialing based on the technology generally described herein. A caller phone device 102 such as a cellular telephone or VolP telephone, software application (including any intermediate device such as a personal computer or add-on phone device such as a box or PC card) that can run a program or other logic is configured with a redialer sensor user interface 104 and redialer sensor mechanism 106. Microsoft Corporation's Office Communicator is an example of a software program that allows calls via the Internet; there are others. The redialer sensor mechanism 106 may be a program (e.g., downloadable) that interacts with an existing telephone program on the device 102, or may be incorporated into an existing telephone program.

In general, the redialer sensor user interface 104 allows the caller (user) to configure the redialing options, and otherwise interact with the redialer sensor mechanism 106. For example, as described below, after initial configuration, the redialer sensor mechanism 106 may provide prompts and the like to guide the caller in making choices as to available sending and redialing-related options.

As generally represented in FIG. 1, the device 102 places a call through a service provider 110 to a called party telephone 112 in a known manner. As part of the communication, the service provider 110 provides (according to a standard protocol) status messages 114 to the caller phone device 102. These status messages 114, which may include “busy” status, “free” status and “call-waiting” status are interpreted by the redialer sensor mechanism 106 and acted upon to provide the caller with an automatic redialing service as described herein.

For calls in which there is no conversation, e.g., a busy status message is received, the caller may instruct the redialer sensor mechanism 106 to sense the line to detect when it becomes free. As described herein, sensing may be accomplished by occasionally (e.g., periodically) calling the number to obtain its status messages, and analyzing them. Note that as also described herein, these status messages 114 are processed by the redialer sensor mechanism 106 sufficiently fast enough that the calls that are used to obtain the messages may be programmatically canceled before the called party telephone rings, whereby called party telephone 112 need not be aware that it is being “called” for the purpose of sensing whether its line is free.

The redialer sensor mechanism 106 may be provided with default settings that a caller (user) may reconfigure via the user interface 104. For example, the caller may choose how many times the called party telephone line is to be called for sensing the line status before halting the sensing process, and how long to wait between making the seamless calls for the purpose of sensing the line status. The caller may also choose (e.g., on a per-call or per-telephone number basis) whether to let the called party know whether the contact attempts are being made or not. For example, a caller may want his wife to know that he is trying to reach her urgently by having the calls at the called party telephone 112 be detected as missed calls, whereas the caller may not want another number, such as that of a casual friend, to even realize his or her line is being sensed as to whether it is free.

As can be readily appreciated, other status messages and the like may be dealt with according to default settings and/or user configuration overrides. For example, one user may want “call-waiting” status messages to be treated as a “busy” message, whereas another user may wish to try to interrupt an existing call via the call-waiting service and thus have the device act as if a regular call is being placed. Another message such as “redirected to answering machine” (if available on a given network) may be likewise treated by the mechanism as busy, or left alone so that the user can leave a message as specified by the user.

As another alternative, a non-answered call on which the caller hangs up, including one that is answered by voicemail before a conversation occurs or within a short time duration, may invoke the sensing operation. Timing and/or signals from the mouthpiece microphone may be used to determine whether the caller has engaged in a conversation; e.g., a caller who does not speak, or speaks in frustration but hangs up right away, can be considered as not having a conversation. Note that although an unanswered call routed to voicemail corresponds to a line that likely will be detected as free, the sensing may still be initiated, possibly after a long delay and/or with longer wait times between sensing operations. Moreover, for a non-answered call, the redialer sensor mechanism 106 may instead first sense for busy status messages that indicate when the called party has resumed using the phone, then start looking for a free status to let the caller know that the called party's phone (which had just been used) is now free.

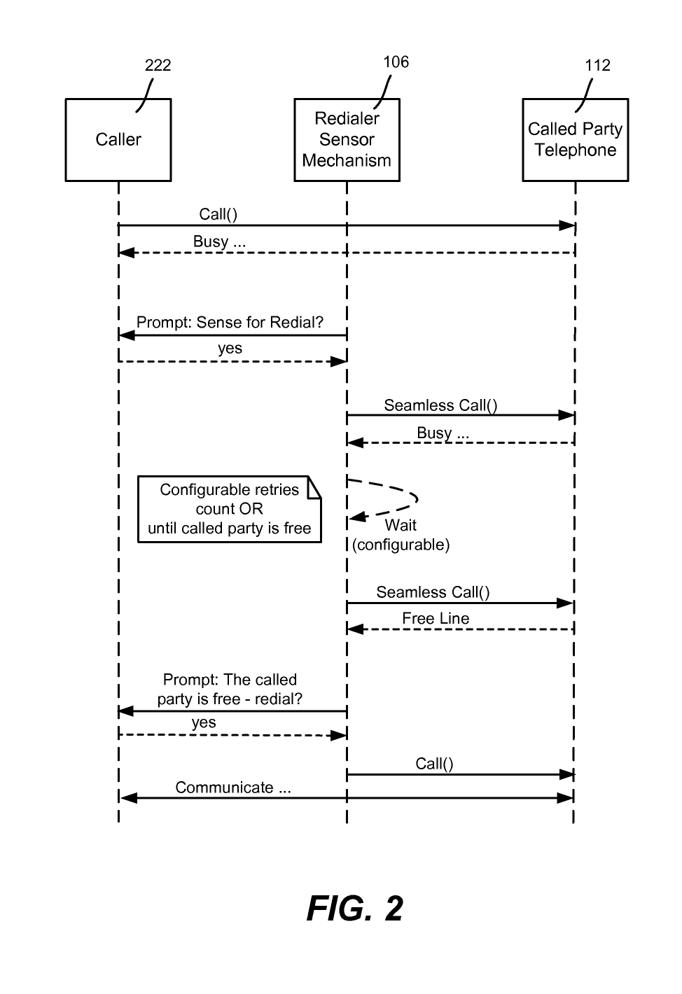

FIG. 2 shows a general, example timing diagram representing actions of a caller 222 (through a telephone program and/or the user interface 104), the redialer sensor mechanism 106 and the called party telephone 112. In general, the caller 222 places a call as normal to the called party telephone 112. Note that in an implementation in which the redialer sensor mechanism 106 is a separate program from the telephone program being used to initiate the call, the redialer sensor mechanism 106 may be already running, e.g., as soon as the telephone program is loaded and run, or as soon as a call is made. If the call is answered, the call proceeds normally.

If instead as represented in FIG. 2 a busy signal is returned then the redialer sensor mechanism 106 detects this state via a status message. At this time, the redialer sensor mechanism 106 begins its user interaction and, if selected, its sensing operations. In one implementation, if no conversation is detected, e.g., the call results in no activity, then the call is also considered as worthy of sensing by the redialer sensor mechanism 106.

As represented in FIG. 2, the redialer sensor mechanism 106 may prompt the caller 222 via the user interface 104 as to whether to automatically sense the call for redialing, (which corresponds to sensing the line as to when it becomes free). If the user responds yes, then sensing begins as described herein (otherwise sensing for redial does not begin). Note that the prompt may be bypassed by a user setting so as to always initiate the redialing/sensing operations. Also, the user may be given an option at this time as to whether the called party is to be notified of each attempt (e.g., via the called party's missed call counter, if any) or not notified via the rapid cancel operation.

A seamless call refers to one performed by the redialer sensor mechanism 106 for sensing the called party's line status, whether or not it shows up on the called party telephone as a missed call. In general, the redialer sensor mechanism 106 periodically or otherwise directs one or more seamless calls to the desired number, receives status messages in return, and interprets the status message back from the service provider to determine how to proceed. For non-detected calling, the status messages are interpreted fast enough to cancel any call to the called party's number before the call is actually acted upon at the called party telephone. In this way, the redialer sensor mechanism 106 may sense the free or busy status of the called line without actually having the call answered, whereby a missed call is not sensed at the called party device. Alternatively, the redialer sensor mechanism 106 may let the call be made to the busy line, whereby a missed call may be detected and counted by the called party telephone 112 if appropriate, but not answered because it is busy.

The redialer sensor mechanism 106 continues to place such seamless calls until a free line is detected, or until a retry limit (which may be user configurable) is reached. The amount of wait time between seamless calls also may be user configurable.

In the example of FIG. 2, the line is detected as being free before the retry limit is reached, whereby the user is prompted as to the line being free, with a redial option provided. Note that this may be accompanied by an audible and/or other notification (e.g., vibration, flashing screen display or the like) so that the caller need not be looking at the caller device 102 to realize that the redial option/free line has become available. In this example, the user chooses to redial, and the redialer sensor mechanism 106 places a regular call on behalf of the user to that number, and the user may now communicate with the called party.

It should be noted that the redialer sensor mechanism 106 may be placing seamless calls to a number of different telephone numbers and thus sensing multiple lines within the same timeframe. In such an event, the prompts to the user may specify which line has become free, and so forth. The redialer sensor mechanism 106 may suspend seamless calling to other lines during the duration of an actual call, reset each retry counter, and so forth. Further, the actions and configuration settings may be different per line, e.g., to let one number see the seamless calls as missed, but not another number, retry one number a different number of times than another before giving up, use different wait times between seamless calls for different numbers, and so on.

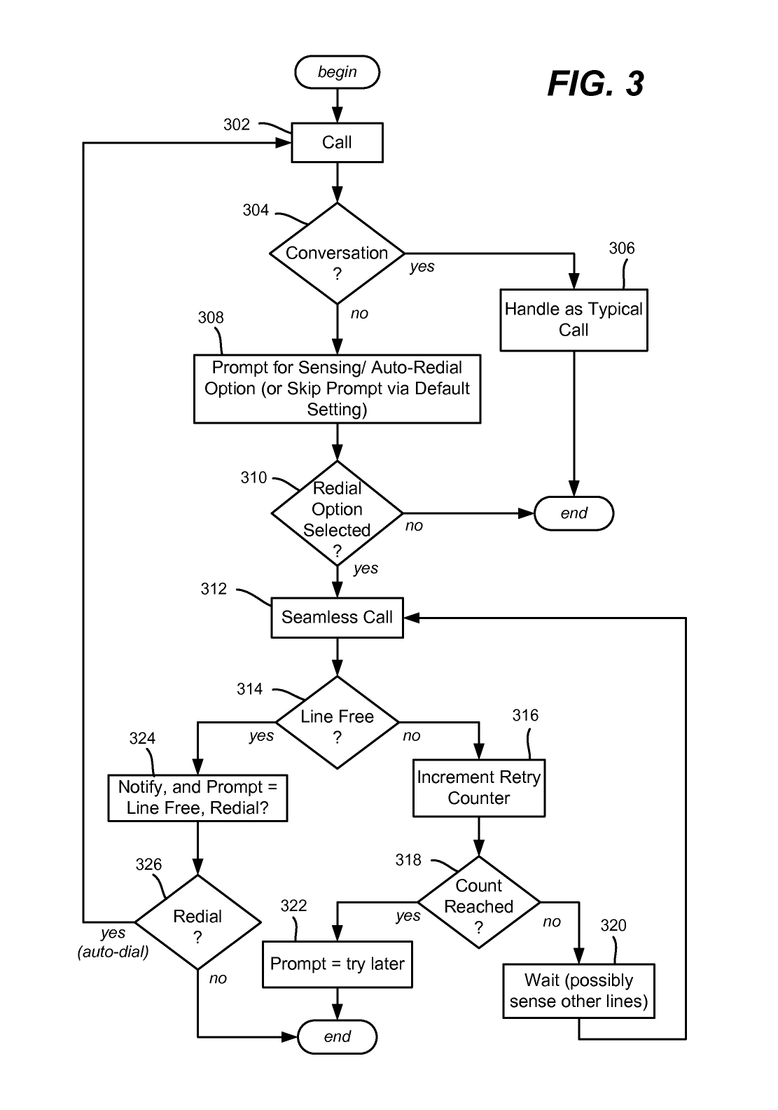

FIG. 3 summarizes example operations of one implementation of a redialer sensor mechanism 106 by way of a flow diagram, following step 302 where the caller makes a call. At step 304, in which the status message and/or other information is processed and evaluated by the redialer sensor mechanism 106. If the call is considered as having resulted in a conversation (e.g., not actually busy or not constructively considered as busy according to configuration settings as described above), then the call is handled as any conventional call (step 306) until the call completes, where “conventional” refers to any call other than a seamless call for the purpose of line sensing as described herein.

If instead at step 304 the called telephone line is busy or considered busy, then the caller is prompted for the automatic sensing/redialing option via step 308. If selected by the caller (or by default) as represented by step 310, then the sensing operation begins.

Step 312 represents the redialer sensor mechanism 106 making a seamless call to obtain the line's status message. If the line is not free, step 314 branches to step 316 to increment the retry counter (e.g., previously initialized, although not shown in FIG. 3 for purposes of simplicity). If the retry count has not been reached at step 318, then step 320 is executed to wait for the next seamless call (by returning to step 312). Note that at this time, one or more other seamless calls for any other lines/phone numbers being sensed may be made. If the retry counter limit is reached, then the user may be suitably prompted at step 322, e.g., to try again later or restart the sensing.

If during the seamless calling-based sensing the line is sensed as free at step 314, (e.g., via an appropriate “free” status message), then the user is notified (e.g., audibly) and visibly prompted as to whether to redial, as represented by step 324. If the user chooses to redial, the redialer sensor mechanism 106 automatically dials a regular call on the caller's behalf and, for example, returns to step 302.

Note that although not shown in FIG. 3, the prompt at step 324 may be timed out. For example, the caller may not receive a timely notification if he or she steps away from the phone, or if on another telephone call. In such a situation, it is possible that the called party line may again be busy at the time that the prompt is eventually seen, such that the caller likely will be annoyed or distrust the program if he or she is simply told the line is free, only to find out that it is not. If more than some threshold time elapses without the prompt being answered, the sensing via seamless calling may automatically resume, possibly with different retry count and/or wait parameters. An alternative is to give the caller an indication as to the exact time that the line became free, so that the caller can see whenever the prompt is no longer current and thus not doubt the program.

As can be readily appreciated, various other aspects may be considered. For example, a user may manually start the sensing operation, because the user expects the line to be busy, or just to see if and when a line is free. Sensing may be started by a timer, e.g., start sensing some user-specified number at 9:00 am without the user first having to place an initial phone call. The device may notify the user of a line's free state via another device, e.g., a mobile phone may generate a notification message such as an email and/or sound received at the user's PC when the sensed telephone line becomes free.

### Exemplary Networked and Distributed Environments

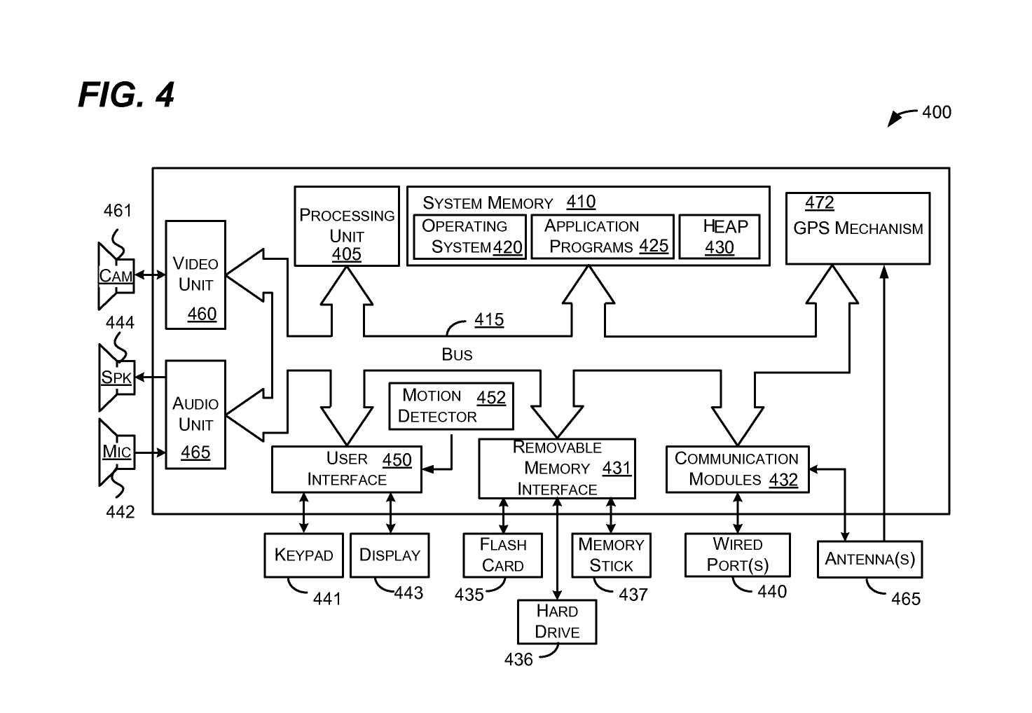

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 may comprise a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-437 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440. Motion detection 452 can be used to determine gestures made with the device 400.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 472. In turn, the GPS mechanism 472 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a media playback device, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
sensing for when a telephone line is free, including initiating a call directed to the telephone line, processing one or more status messages returned in response to the call, and canceling the call; and
taking further action when a status message indicates that the line is free, including notifying a user as to the line having a free status.

2. The method of claim 1 wherein sensing for when the telephone line is free comprises initiating another call directed to the telephone line, processing one or more other status messages returned in response to the call, and canceling the other call.

3. The method of claim 2 wherein canceling the call comprises canceling the call before the call is detected as a missed call by a called party device coupled to the telephone line.

4. The method of claim 1 wherein canceling the call comprises canceling the call after the call is able to be detected as a missed call by a called party device coupled to the telephone line.

5. The method of claim 1 further comprising, prompting a user to determine whether to begin sensing for when the telephone line is free.

6. The method of claim 5 wherein prompting the user is performed in response to determining that no actual conversation occurred with respect to a conventional call attempt.

7. The method of claim 1 wherein sensing for when the telephone line is free comprises performing a plurality of calls directed to the telephone line, and for each call, processing one or more status messages returned in response to the call, and canceling that call.

8. The method of claim 7 further comprising, halting sensing when the plurality of calls directed to the telephone line reaches a limit.

9. The method of claim 7 further comprising, waiting a configurable amount of time between each call.

10. The method of claim 1 wherein sensing for when the telephone line is free occurs in a same timeframe as sensing for when at least one other telephone line is free.

11. In a computing environment, a system comprising:
a redialer sensor mechanism configured to interpret one or more status messages returned in response to a call attempt to a called party telephone; and
a user interface by which the redialer sensor mechanism interacts with a user, including to obtain a user instruction whether to sense a non-free telephone line for when the telephone line becomes free, and, if the instruction is to sense the telephone line, the redialer sensor mechanism further configured to sense the telephone line by operating to receive status messages and to interpret the status messages, and to direct the user interface to notify the user when the telephone line becomes free.

12. The system of claim 11 wherein the user interface notifies the user when the line becomes free via an audible, visible or tactile notification, or any combination of an audible, visible or tactile notification.

13. The system of claim 11 wherein the user interface notifies the user when the line becomes free, and further prompts the user to select whether to redial a conventional call.

14. The system of claim 11 wherein the redialer sensor mechanism is incorporated into a mobile telephone.

15. The system of claim 11 wherein the redialer sensor mechanism is incorporated into a VolP telephone, a software application program, or an add-on telephone device.

16. The system of claim 11 wherein the redialer sensor mechanism operates to receive status messages by making one or more calls to the telephone line and canceling each call.

17. The system of claim 16 wherein the user interface includes a mechanism by which a user is able to enter one or more configuration parameters, including a sensing retry count parameter corresponding to a maximum number of calls used for sensing, or a wait time parameter to delay between calls used for sensing, or both a sensing retry count parameter and a wait time parameter.

18. One or more computer-readable media having computer-executable instructions, which when executed perform steps, comprising,
(a) detecting that a call to a telephone line ended without an actual conversation;
(b) determining that a user wants to have the telephone line sensed for when the line is free;
(c) sensing the line, including placing a call to the line to receive one or more status messages corresponding to the free or busy state of the line, and canceling the call;
(d) processing the one or more status messages to determine whether the line is free, and if the line is not free, returning to step (c) for a plurality of times, and if the line is free, notifying the user that the line is free.

19. The one or more computer-readable media of claim 18 having further computer-executable instructions comprising, sensing at least one other line while performing steps (c) and (d).

20. The one or more computer-readable media of claim 18 wherein detecting that the call to the telephone line ended without an actual conversation comprises using microphone signals, or a timer, or both microphone signals and a timer to distinguish between a conversation and a non-conversation.
